(19) United States
(12) Patent Application Publication
(10) Pub. No.: US 2025/0377858 A1
(43) Pub. Date: Dec. 11, 2025

(54) PROCESSOR AND METHOD FOR CONTROLLING OPERATION OF PROCESSOR

(71) Applicant: Fujitsu Limited, Kawasaki-shi (JP)

(72) Inventor: YASUNOBU AKIZUKI, Kawasaki (JP)

(73) Assignee: Fujitsu Limited, Kawasaki-shi (JP)

(21) Appl. No.: 19/229,533

(22) Filed: Jun. 5, 2025

(30) Foreign Application Priority Data
Jun. 11, 2024 (JP) 2024-094417

(51) Int. Cl. G06F 7/499

(52) U.S. Cl. CPC G06F 7/49915

(57) ABSTRACT

A processor includes a plurality of cores each including a floating-point arithmetic unit; a frequency voltage control unit provided corresponding to each of the plurality of cores, the frequency voltage control unit being configured to supply a clock having a variable frequency and a power supply voltage having a variable voltage to the corresponding core; and an instruction issuance control unit provided in each of the plurality of cores, the instruction issuance control unit being configured to control issuance of a floating-point arithmetic instruction to the floating-point arithmetic unit and lower an issuance frequency of floating-point arithmetic instructions to the floating-point arithmetic unit as a current frequency value of the clock is larger than a reference frequency value, or as a current power supply voltage value is larger than a reference power supply voltage value.

### CROSS-REFERENCE TO RELATED APPLICATIONS

The present application is based upon and claims the benefit of priority from the prior Japanese Patent Application No. 2024-094417 filed on Jun. 11, 2024, with the Japanese Patent Office, the entire contents of which are incorporated herein by reference.

### FIELD

The disclosure discussed herein relates to a processor and a method for controlling an operation of a processor.

### BACKGROUND

A processor is known to include a pipeline including instruction units and execution units connected in series, and local clock buffers configured to generate, from a common clock, clocks to be supplied to the instruction units and the execution units. Each local clock buffer inhibits large current fluctuation by starting clock supply in order from the stage on the upstream side of the pipeline when the stall bit is negated, and inhibits the occurrence of noise (for example, refer to Patent Document 1).

### RELATED-ART DOCUMENT

### [Patent Document]

[Patent Document 1] Japanese National Publication of International Patent Application No. 2007-521538

### SUMMARY

According to an aspect of the present disclosure, a processor includes:
a plurality of cores each including a floating-point arithmetic unit;
a frequency voltage control unit provided corresponding to each of the plurality of cores, the frequency voltage control unit being configured to supply a clock having a variable frequency and a power supply voltage having a variable voltage to the corresponding core; and
an instruction issuance control unit provided in the each of the plurality of cores, the instruction issuance control unit being configured to control issuance of a floating-point arithmetic instruction to the floating-point arithmetic unit and lower an issuance frequency of floating-point arithmetic instructions to the floating-point arithmetic unit as a current frequency value of the clock is larger than a reference frequency value, or as a current power supply voltage value is larger than a reference power supply voltage value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a processor according to an embodiment;

FIG. 2 is an explanatory diagram illustrating an example of control of the issuance frequency of floating-point arithmetic instructions in each core in FIG. 1;

FIG. 3 is a block diagram illustrating an example of a processor according to another embodiment;

FIG. 4 is a flowchart illustrating an outline of an operation of each core of the processor in FIG. 3;

FIG. 5 is a block diagram illustrating an example of an issuance frequency determination unit in FIG. 3;

FIG. 6 is a flowchart illustrating an example of an operation of the issuance frequency determination unit in FIG. 5;

FIG. 7 is a table illustrating an example of an operation of the counter and the AND circuit of the issuance frequency determination unit in FIG. 5;

FIG. 8 is a table illustrating another example of an operation of the counter and the AND circuit of the issuance frequency determination unit in FIG. 5;

FIG. 9 is a flowchart illustrating an example of an operation of the instruction execution unit in FIG. 3;

FIG. 10 is a block diagram illustrating an example of a processor according to still another embodiment;

FIG. 11 is a table illustrating an example of adjustment of a current frequency value and a current power supply voltage value by the frequency voltage control unit in FIG. 10;

FIG. 12 is a block diagram illustrating an example of a processor according to yet another embodiment;

FIG. 13 is an explanatory diagram illustrating an example of an operation in a case where the issuance frequency of floating-point arithmetic instructions is insufficient in each core of the processor in FIG. 12; and

FIG. 14 is a flowchart illustrating an example of an operation of each core of the processor in FIG. 12.

### DESCRIPTION OF EMBODIMENTS

A recent multi-core processor may have a dynamic voltage and frequency scaling (DVFS) function capable of dynamically controlling a clock frequency and a power supply voltage for each core. For example, the processing performance can be improved by increasing the clock frequency and the power supply voltage when a program with low power consumption is executed using the DVFS function.

However, when the clock frequency and the power supply voltage of the core of interest are high, and when a program with high power consumption is executed by another core, the clock frequency and the power supply voltage of the core of interest are lowered such that the electric-current consumption of the processor does not exceed the upper limit. However, in the control by the DVFS, a predetermined cycle is required until the clock frequency and the power supply voltage are lowered. Therefore, the processor does not sufficiently increase the clock frequency and the power supply voltage even when executing a program with low power consumption, and inhibits the power consumption of the processor from exceeding the upper limit.

Note that the upper limit of the electric-current consumption of the processor can be increased by increasing the number of power supply pins of the processor. However, when the number of power supply pins is increased, the size of the package increases, and the size of a board on which the package is mounted may also increase. Therefore, even when the upper limit of the electric-current consumption of the processor can be increased, the cost of the processor and the system including the processor increases.

In one aspect, the present disclosure aims to inhibit the electric-current consumption of a processor from exceeding an upper limit when the clock frequency and supply voltage are variably controlled for each of a plurality of cores.

According to an aspect of the present disclosure, an electric-current consumption of a processor having a plurality of cores can be inhibited from exceeding an upper limit value when variably controlling a clock frequency and a power supply voltage in each of the plurality of cores.

Hereinafter, embodiments will be described with reference to the accompanying drawings. In the following description, the same reference numeral as the signal name is used for a signal line through which a signal is transmitted, and the same reference numeral as the voltage name is used for a voltage line through which a voltage is supplied. Although not particularly specified, the processor described below is a superscalar processor and executes instructions in parallel by pipeline processing.

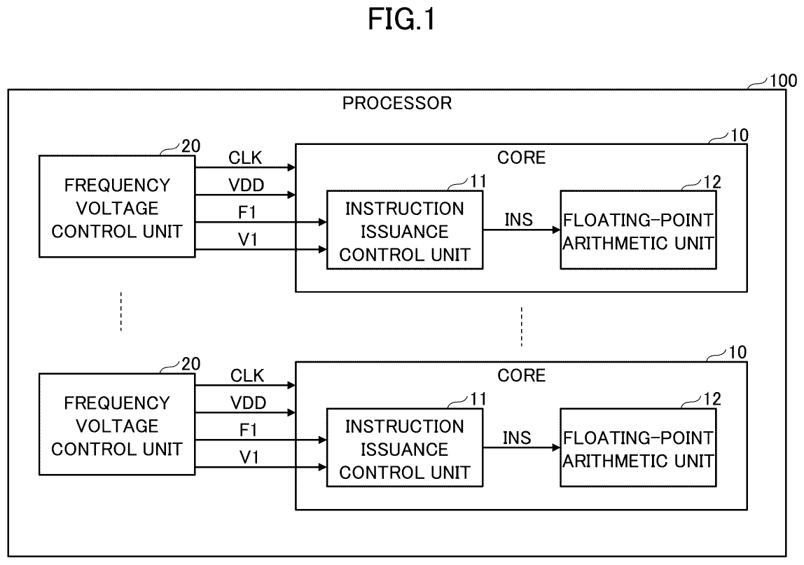

FIG. 1 illustrates an example of a processor according to an embodiment. The processor 100 illustrated in FIG. 1 includes a plurality of cores 10 and frequency voltage control units 20 provided corresponding to the respective cores 10. Each core 10 includes a floating-point arithmetic unit 12 that executes a floating-point arithmetic instruction INS and an instruction issuance control unit 11 that issues the floating-point arithmetic instruction INS to the floating-point arithmetic unit 12.

The frequency voltage control unit 20 supplies a clock CLK having a variable frequency and a power supply voltage VDD having a variable voltage to the corresponding core 10. The frequency voltage control unit 20 outputs a frequency value F1 indicating a frequency value of the clock CLK and a power supply voltage value V1 indicating a power supply voltage value of the power supply voltage VDD to the instruction issuance control unit 11 of the corresponding core 10.

Each core 10 operates based on the clock CLK and the power supply voltage VDD received from the frequency voltage control unit 20. That is, the processor 100 has a dynamic voltage and frequency scaling (DVFS) function of dynamically controlling the frequency of the clock CLK and the power supply voltage VDD for each core 10.

The instruction issuance control unit 11 lowers the issuance frequency of floating-point arithmetic instructions to the floating-point arithmetic unit 12 as the current frequency of the clock CLK becomes higher based on the frequency value F1, or as the current power supply voltage VDD becomes higher based on the power supply voltage value V1.

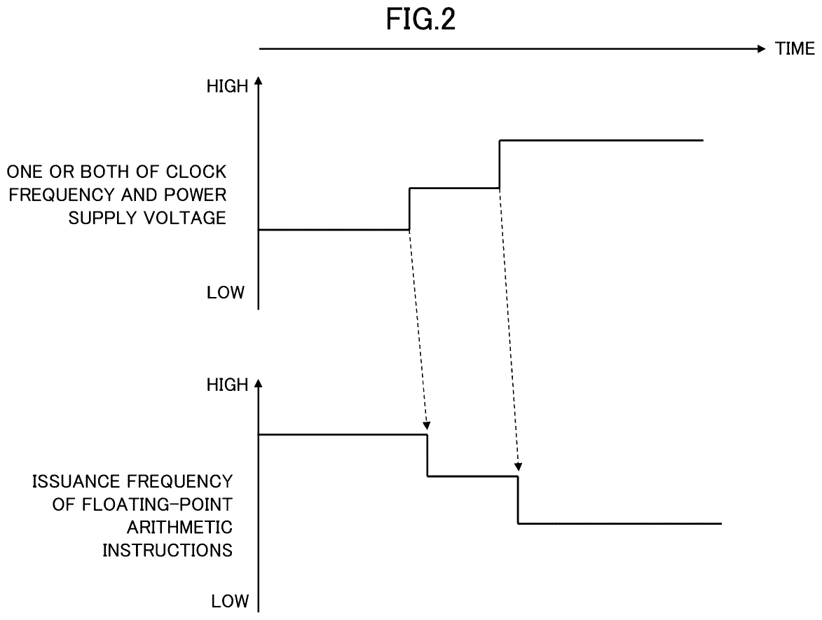

FIG. 2 illustrates an example of control of the issuance frequency of floating-point arithmetic instructions INS in each core 10 in FIG. 1. As described with reference to FIG. 1, the instruction issuance control unit 11 lowers the issuance frequency of the floating-point arithmetic instructions to the floating-point arithmetic unit 12 as the current frequency of the clock CLK is higher, or as the current power supply voltage VDD is higher. Although indicated by reversing the time axis in FIG. 2, the instruction issuance control unit 11 increases the issuance frequency of floating-point arithmetic instructions to the floating-point arithmetic unit 12 as the current frequency of the clock CLK is lower, or as the current power supply voltage VDD is lower.

For example, when the frequency of the clock CLK supplied to the core 10 is increased, the frequency voltage control unit 20 outputs a frequency value F1 indicating the increased frequency value to the instruction issuance control unit 11. The instruction issuance control unit 11 detects that the frequency of the clock CLK has increased based on the frequency value F1, and lowers the issuance frequency of floating-point arithmetic instructions to the floating-point arithmetic unit 12 according to the amount of increase in the frequency.

When the power supply voltage VDD supplied to the core 10 is increased, the frequency voltage control unit 20 outputs a power supply voltage value V1 indicating a value of the increased power supply voltage VDD to the instruction issuance control unit 11. The instruction issuance control unit 11 detects that the power supply voltage VDD has increased based on the power supply voltage value V1, and lowers the issuance frequency of the floating-point arithmetic instructions INS to the floating-point arithmetic unit 12 according to the amount of increase in the power supply voltage VDD.

Further, when the frequency voltage control unit 20 increases the frequency of the clock CLK and the power supply voltage VDD supplied to the core 10, the frequency voltage control unit 20 outputs a frequency value F1 indicating the increased frequency and a power supply voltage value V1 indicating the increased power supply voltage VDD to the instruction issuance control unit 11. The instruction issuance control unit 11 detects that the frequency of the clock CLK and the power supply voltage VDD have increased based on the frequency value F1 and the power supply voltage V1, and lowers the issuance frequency of the floating-point arithmetic instructions INS to the floating-point arithmetic unit 12.

This can inhibit an increase in power consumption of the processor 100 due to an increase in one or both of the frequency of the clock CLK and the power supply voltage VDD. Therefore, even when one or both of the frequency of the clock CLK and the power supply voltage VDD of the core 10 are increased, the frequency of the clock CLK and the power supply voltage VDD of the core 10 do not have to be decreased. Therefore, it is possible to inhibit the power consumption of the processor 100 from exceeding the upper limit before the frequency of the clock CLK and the power supply voltage VDD of the core 10 are lowered to predetermined values.

By changing the issuance frequency of the floating-point arithmetic instructions in conjunction with the change in the frequency of the clock CLK and the power supply voltage VDD, it is possible to inhibit the fluctuation in the power consumption of the core 10 due to the change in the frequency of the clock CLK and the power supply voltage VDD. Therefore, even when the power consumption of another core 10 increases, each core 10 can continue the execution of the floating-point arithmetic instruction without lowering the frequency of the clock CLK and the power supply voltage VDD of the core 10. That is, each core 10 can continue the operation using the appropriate frequency of the clock CLK and power supply voltage VDD without being affected by the operation of the other cores 10.

Since the frequency of the clock CLK and the power supply voltage VDD do not need to be controlled in conjunction with each other among the plurality of cores 10, it is possible to simplify the control of a power control unit or the like that manages the frequency of the clock CLK and the power supply voltage VDD of each of the plurality of cores 10. Since each core 10 individually controls the power consumption, the power consumption of the processor 100 can be inhibited from exceeding the upper limit.

As described above, in the embodiment illustrated in FIGS. 1 and 2, when the frequency of the clock CLK and the power supply voltage VDD are variably controlled in each of the plurality of cores 10, the issuance frequency of floating-point arithmetic instructions is changed in conjunction with the change in the frequency of the clock CLK and the power supply voltage VDD for each core 10. This can inhibit the electric-current consumption of the processor 100 from exceeding the upper limit value.

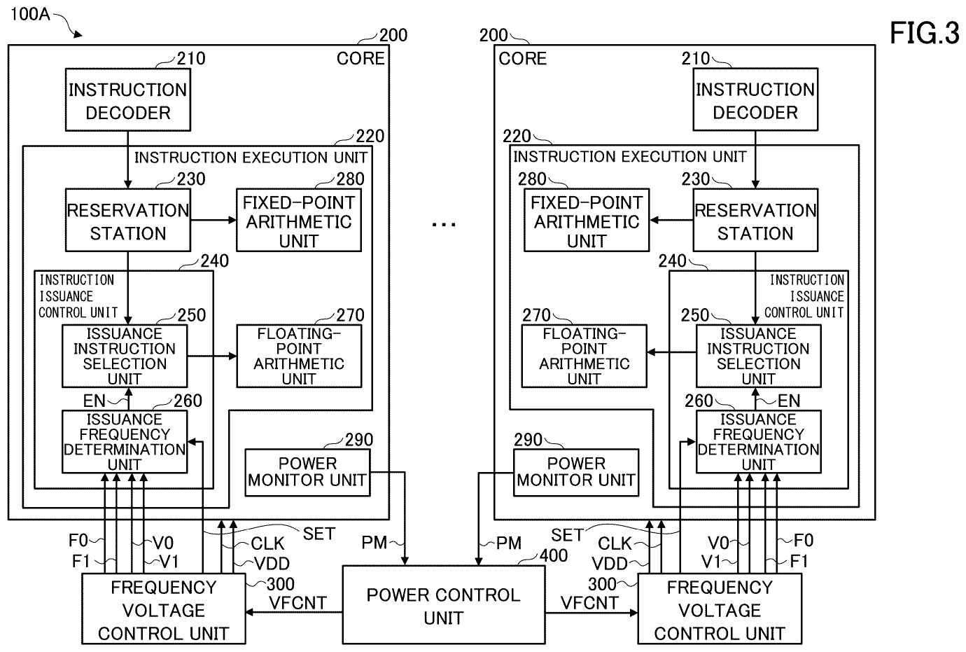

FIG. 3 illustrates an example of a processor according to another embodiment. The processor 100A illustrated in FIG. 3 includes a plurality of cores 200, frequency voltage control units 300 provided for the respective cores 200, and a power control unit 400 provided in common to the plurality of cores 200. Each core 200 includes an instruction decoder 210, an instruction execution unit 220, and a power monitor unit 290. The instruction execution unit 220 includes a reservation station 230, an instruction issuance control unit 240 including an issuance instruction selection unit 250 and an issuance frequency determination unit 260, a floating-point arithmetic unit 270, and a fixed-point arithmetic unit 280.

Each core 200 may include a primary cache, an instruction fetch unit, an instruction buffer, and the like, in addition to the configuration illustrated in FIG. 3. The instruction execution unit 220 may include an operand address generator used when a load instruction or a store instruction is executed, in addition to the configuration illustrated in FIG. 3.

The power monitor unit 290 monitors the amount of power consumed in the core 200 and outputs power monitor information PM indicating the monitored amount of power consumption to the power control unit 400 at a predetermined frequency. The power control unit 400 calculates the total power consumption of the plurality of cores 200 based on the power monitor information PM received from each core 200, and obtains the frequency of the clock CLK and the power supply voltage VDD to be supplied to each core 200 based on the calculation result and the power consumption of each core 200. The power control unit 400 outputs a frequency voltage control signal VFCNT indicating the frequency of the clock CLK and the power supply voltage VDD to the frequency voltage control unit 300 corresponding to each core 200 at a predetermined frequency. The power monitor information PM is an example of power information, and the frequency voltage control signal VFCNT is an example of change information for changing the frequency of the clock CLK and the power supply voltage VDD.

The frequency voltage control unit 300 may include a regulator (not illustrated) that generates a power supply voltage VDD and a Phase Locked Loop (PLL) (not illustrated) that generates a clock CLK. When the frequency voltage control unit 300 receives the frequency voltage control signal VFCNT, the frequency voltage control unit 300 changes the frequency of the clock CLK to the frequency indicated by the frequency voltage control signal VFCNT and changes the power supply voltage VDD to the voltage indicated by the frequency voltage control signal VFCNT. Then, the frequency voltage control unit 300 outputs the changed frequency of the clock CLK and the changed power supply voltage VDD to the corresponding core 200.

Every time the frequencies and the power supply voltages VDD are changed, the frequency voltage control unit 300 outputs a setting signal SET, the frequency value F1 indicating the changed frequency, and the power supply voltage value V1 indicating the changed power supply voltage VDD to the issuance frequency determination unit 260 of the corresponding core 200. The frequency voltage control unit 300 outputs a reference frequency value F0 indicating a reference value of the frequency of the clock CLK and a reference power supply voltage value V0 indicating a reference value of the power supply voltage VDD to the issuance frequency determination unit 260 of the corresponding core 200. For example, the reference frequency value F0 and the reference power supply voltage value V0 are not changed while the processor 100A is activated. In the following, the frequency value F1 is also referred to as a current frequency value F1, and the power supply voltage value V1 is also referred to as a current power supply voltage value V1.

The instruction decoder 210 decodes an instruction output from an instruction buffer (not illustrated), for example, and outputs the decoded instruction to the reservation station 230. For example, the instruction decoder 210 decodes a floating-point arithmetic instruction, a fixed-point arithmetic instruction, a load instruction, a store instruction, and the like.

The reservation station 230 includes a queue for holding instructions output from the instruction decoder 210, and outputs the instructions held in the queue in an executable order. That is, the instruction is executed out of order (Out-of-Order Execution). The reservation station 230 outputs the floating-point arithmetic instruction to the issuance instruction selection unit 250 of the instruction issuance control unit 240. The reservation station 230 outputs the fixed-point arithmetic instruction to the fixed-point arithmetic unit 280 without passing through the instruction issuance control unit 240. The reservation station 230 outputs the load instruction and the store instruction to an operand address generator (not illustrated) without passing through the instruction issuance control unit 240.

The reservation station 230 deletes the floating-point arithmetic instruction whose execution is completed by the floating-point arithmetic unit 270 from the queue, and deletes the fixed-point arithmetic instruction whose execution is completed by the fixed-point arithmetic unit 280 from the queue. The instruction execution unit 220 may include a commit control unit (not illustrated) that completes the execution of the instruction in order.

When the execution of the floating-point arithmetic instruction output to the instruction issuance control unit 240 is inhibited in accordance with a decrease in the issuance frequency of the floating-point arithmetic instructions by the instruction issuance control unit 240, the reservation station 230 holds the floating-point arithmetic instruction without deleting the floating-point arithmetic instruction from the queue. The reservation station 230 is an example of a scheduler.

When the enable signal EN from the issuance frequency determination unit 260 indicates an enabled state at the time at which the issuance instruction selection unit 250 receives the floating-point arithmetic instruction from the reservation station 230, the issuance instruction selection unit 250 issues the floating-point arithmetic instruction to the floating-point arithmetic unit 270. When the enable signal EN from the issuance frequency determination unit 260 indicates a disabled state at the time at which the issuance instruction selection unit 250 receives the floating-point arithmetic instruction from the reservation station 230, the issuance instruction selection unit 250 inhibits the issuance of the floating-point arithmetic instruction to the floating-point arithmetic unit 270.

When there are a floating-point arithmetic instruction with large power consumption and a floating-point arithmetic instruction with small power consumption, the issuance instruction selection unit 250 may perform issuance control by the enable signal EN on the floating-point arithmetic instruction whose power consumption during execution by the floating-point arithmetic unit 270 is equal to or larger than a reference value. For example, when the instruction decoder 210 decodes a floating-point arithmetic instruction whose power consumption is equal to or larger than the reference value, the instruction decoder 210 adds a high-frequency flag indicating that the power consumption is equal to or larger than the reference value to the decoded floating-point arithmetic instruction, and stores the decoded floating-point arithmetic instruction in the reservation station 230. When the instruction decoder 210 decodes a floating-point arithmetic instruction whose power consumption is smaller than the reference value, the instruction decoder 210 stores the decoded floating-point arithmetic instruction in the reservation station 230 without adding a high-frequency flag to the instruction.

When the issuance instruction selection unit 250 receives a floating-point arithmetic instruction to which a high-frequency flag is added from the reservation station 230, the issuance instruction selection unit 250 controls the issuance frequency of the received floating-point arithmetic instruction by the enable signal EN. When the issuance instruction selection unit 250 receives a floating-point arithmetic instruction to which a high-frequency flag is not added from the reservation station 230, the issuance instruction selection unit 250 immediately issues the received floating-point arithmetic instruction to the floating-point arithmetic unit 270.

For example, a floating-point arithmetic instruction whose power consumption is equal to or larger than the reference value is a single instruction multiple data (SIMD) arithmetic instruction, and a floating-point arithmetic instruction whose power consumption is smaller than the reference value is a single instruction single data (SISD) arithmetic instruction. For example, when one element is an operation of a 64-bit width, the SIMD operation instruction executes operations of two elements, four elements, eight elements, or the like in parallel, and thus the power consumption is increased by the number of elements as compared with the SISD operation instruction that executes an operation of one element.

The issuance frequency determination unit 260 is initialized every time the setting signal SET is received, and obtains the output frequency of enable signals EN using the reference frequency value F0, the reference power supply voltage value V0, the current frequency value F1, and the current power supply voltage value V1, and outputs the enable signal EN at the obtained frequency. The output of the enable signal EN indicates that the enable signal EN is set to an enabled state. For example, the issuance frequency determination unit 260 lowers the issuance frequency of the enable signals EN as the current frequency value F1 is higher than the reference frequency value F0, or as the current power supply voltage value V1 is higher than the reference power supply voltage value V0. The issuance frequency of the enable signals EN indicates the issuance frequency of floating-point arithmetic instructions to the floating-point arithmetic unit 270.

The issuance frequency of the enable signals EN may be obtained by, for example, Equation (1). When the issuance frequency obtained by Equation (1) is equal to or larger than “1”, the issuance frequency is set to “1”. By using Equation (1), the issuance frequency of the enable signals EN can be finely adjusted. In other embodiments, the issuance frequency of the enable signals EN may also be obtained using Equation (1).

$$Issuance frequency of enable signals EN = ( reference frequency value F 0 / current frequency value F 1 ) ⨯ ( reference power supply voltage value V 0 / current power supply voltage value V 1 ) \qquad ( 1 )$$

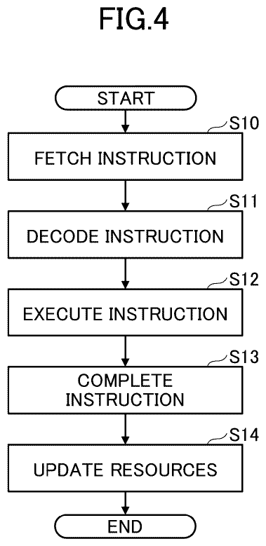

FIG. 4 illustrates an outline of an operation of each core 200 of the processor 100A in FIG. 3. The core 200 repeatedly executes the operation illustrated in FIG. 4. First, in step S10, the instruction fetch unit of the core 200 outputs an address indicated by a program counter or the like to a memory such as a primary cache, and fetches an instruction held in the memory. For example, the instruction fetch unit sequentially holds the fetched instructions in the instruction buffer.

Next, in step S11, the instruction decoder 210 of the core 200 reads and decodes the instruction from the instruction buffer, and transfers the decoded instruction to the reservation station 230. When a reservation station is provided for each type of an arithmetic unit, the decoded instruction is transferred to the reservation station corresponding to the arithmetic unit that executes the instruction.

Next, in step S12, the reservation station 230 of the core 200 holds the instruction transferred from the instruction decoder 210 in a queue, issues the instruction ready for execution to an arithmetic unit such as the floating-point arithmetic unit 270, and causes the arithmetic unit to execute the operation (out of order).

Next, in step S13, the completion control unit such as the commit control unit of the core 200 determines the completion of the instruction whose execution has been completed according to the description order of the program. Next, in step S14, the core 200 updates programmable resources such as a program counter and a register used in the instruction determined to be completed by the completion control unit.

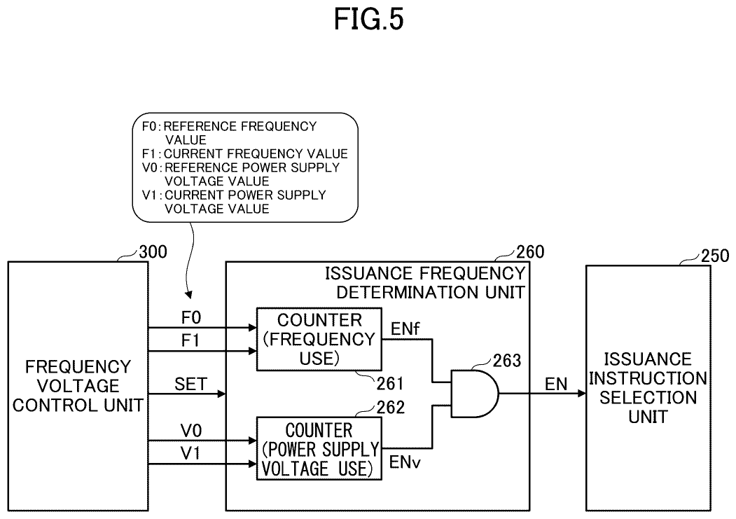

FIG. 5 illustrates an example of the issuance frequency determination unit 260 in FIG. 3. The issuance frequency determination unit 260 includes a frequency-use counter 261, a power supply voltage-use counter 262, and an AND circuit 263. The counter 261 performs a process of adding the reference frequency value F0 to the counter value and a process of setting the enable signal ENf to be enabled and subtracting the current frequency value F1 from the counter value when the counter value is equal to or larger than the current frequency value F1.

The counter 262 performs a process of adding the reference power supply voltage value V0 to the counter value, and a process of setting the enable signal ENv to be enabled and subtracting the current power supply voltage value V1 from the counter value when the counter value becomes equal to or larger than the current power supply voltage value V1.

The AND circuit 263 sets the enable signal EN to an enabled state when both of the enable signals ENf and ENv are enabled, and sets the enable signal EN to an disabled state when one or both of the enable signals ENf and ENv are disabled. For example, each of the enable signals ENf and ENv is set to a high level when enabled, and is set to a low level when disabled. For example, the enable signal EN is at a high level in the enabled state, and the enable signal EN is at a low level in the disabled state.

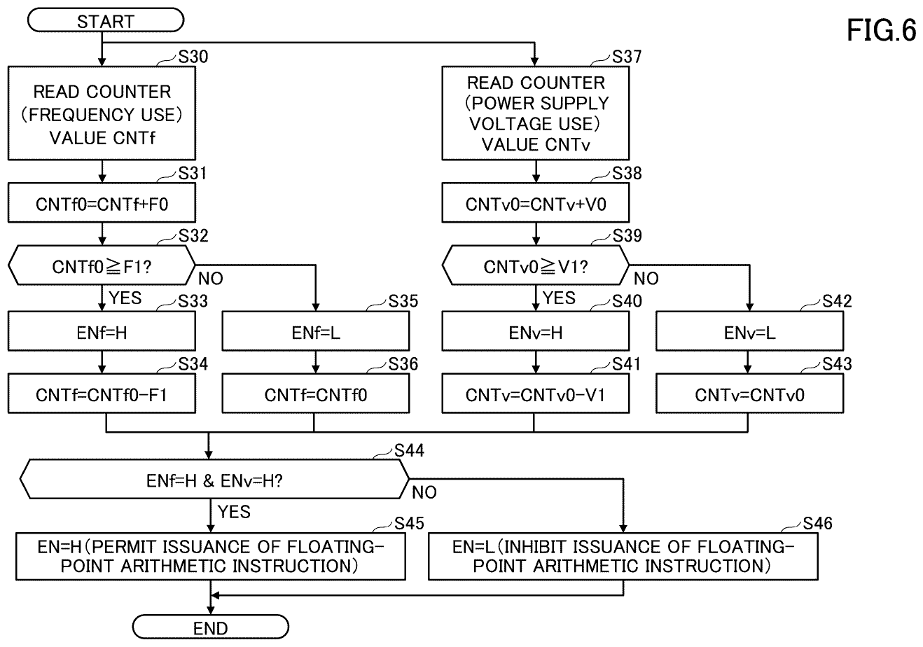

FIG. 6 illustrates an example of the operation of the issuance frequency determination unit in FIG. 5. The operation illustrated in FIG. 6 is executed, for example, for each cycle of the processor 100A. For example, the processor 100A can input an instruction to the arithmetic unit in each cycle. Steps S30 to S36 indicate the operation of the frequency-use counter 261. Steps S37 to S43 indicate the operation of the power supply voltage-use counter 262. Steps S44 to S46 indicate the operation of the AND circuit 263. Steps S30 to S36 and steps S37 to S43 are executed in parallel. The counter 261 counts a value indicating the frequency of the clock CLK, and the counter 262 counts a value indicating the power supply voltage VDD.

In step S30, the counter 261 reads the counter value CNTf. Next, in step S31, the counter 261 adds the reference frequency value F0 to the read counter value CNTf and holds the result as a counter value CNTf0.

Next, in step S32, when the counter value CNTf0 is equal to or larger than the current frequency value F1, the counter 261 sets the enable signal ENf to the high level H in step S33, and executes step S34. On the other hand, when the counter value CNTf0 is smaller than the current frequency value F1, the counter 261 sets the enable signal ENf to the low level L in step S35, and executes step S36.

In step S34, the counter 261 subtracts the current frequency value F1 from the counter value CNTf0 and holds the result as the counter value CNTf. In step S36, the counter 261 holds the counter value CNTf0 as the counter value CNTf.

In step S37, the counter 262 reads the counter value CNTv. Next, in step S38, the counter 262 adds the reference power supply voltage value V0 to the read counter value CNTv and holds the result as a counter value CNTv0.

Next, in step S39, when the counter value CNTv0 is equal to or larger than the current power supply voltage value V1, the counter 262 sets the enable signal ENv to the high level H in step S40, and executes step S41. On the other hand, when the counter value CNTv0 is smaller than the current power supply voltage value V1, the counter 262 sets the enable signal ENv to the low level L in step S42, and executes step S43.

In step S41, the counter 262 subtracts the current power supply voltage value V1 from the counter value CNTv0 and holds the result as the counter value CNTv. In step S43, the counter 262 holds the counter value CNTv0 as the counter value CNTv.

After one of steps S34 and S36, and one of steps S41 and S43 are executed, step S44 is performed. In step S44, when both of the enable signals ENf and ENv are at the high level H, the AND circuit 263 sets the enable signal EN to the high level H in step S45, and permits the issuance of the floating-point arithmetic instruction. When one or both of the enable signals ENf and ENv are at the low level L, the AND circuit 263 sets the enable signal EN to the low level L in step S46, and inhibits the issuance of the floating-point arithmetic instruction. Then, the operation illustrated in FIG. 6 is terminated.

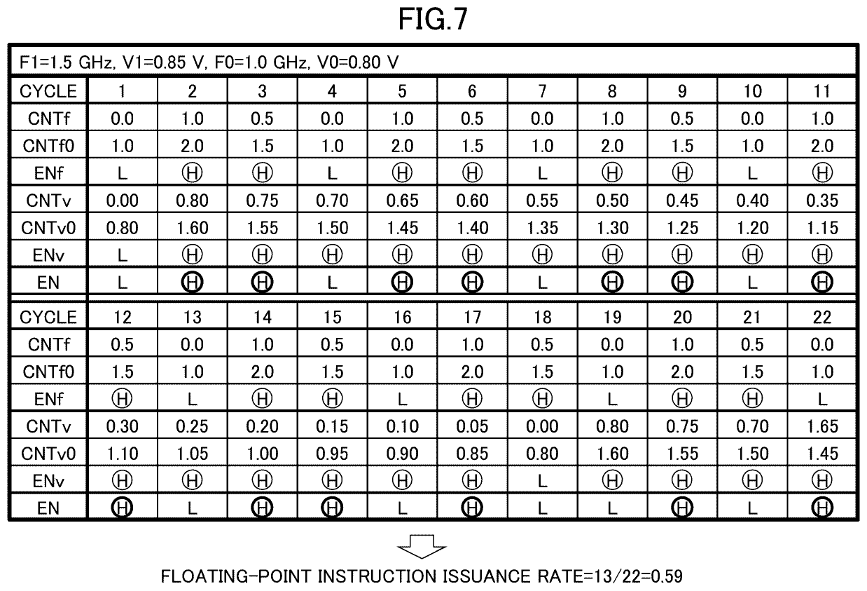

FIG. 7 illustrates an example of the operation of the counters 261 and 262 and the AND circuit 263 of the issuance frequency determination unit 260 in FIG. 5. FIG. 7 illustrates the operation when the current frequency value F1 is 1.5 GHz and the current power supply voltage value V1 is 0.85 V. The reference frequency value F0 is set to 1.0 GHz, and the reference power supply voltage value V0 is set to 0.80 V.

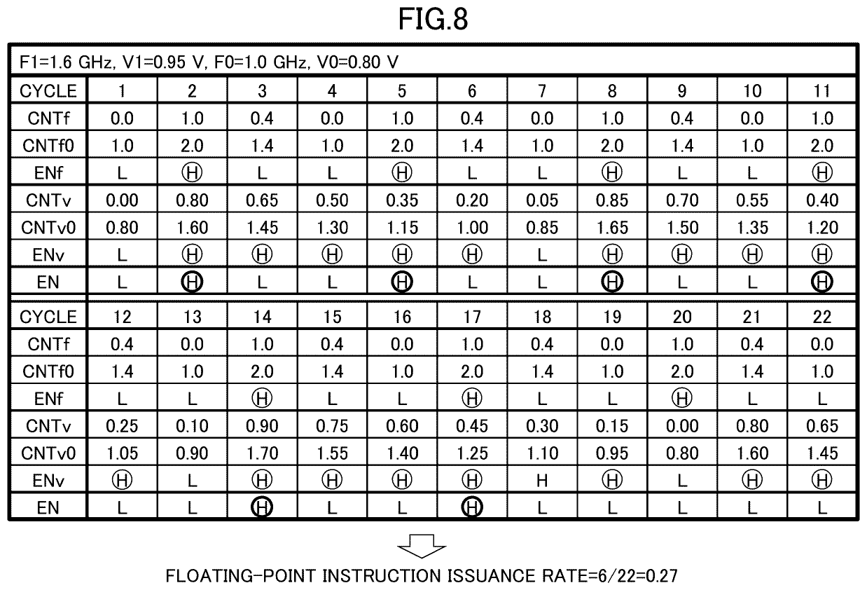

In FIG. 7 and FIG. 8 described later, the floating-point arithmetic instruction is transferred from the reservation station 230 to the instruction issuance control unit 240 in each cycle. Alternatively, FIGS. 7 and 8 illustrate only cycles in which a floating-point arithmetic instruction is issued from the reservation station 230 or only cycles in which a floating-point arithmetic instruction such as an SIMD arithmetic instruction whose power consumption is equal to or larger than a reference value is issued.

The issuance frequency determination unit 260 receives the setting signal SET in the cycle immediately before the cycle 1, resets the counter value CNTf of the counter 261 to 0.0 in the cycle 1, and resets the counter value CNTv of the counter 262 to 0.00.

First, in cycle 1, the counter 261 adds the reference frequency value F0 (1.0) to the counter value CNTf (=0.0), and holds the result as the counter value CNTf0 (=1.0). Since the counter value CNTf0 (=1.0) is smaller than the current frequency value F1 (=1.5), the counter 261 sets the enable signal ENf to the low level L and sets the counter value CNTf to the counter value CNTf0. The counter value CNTf is updated in the next cycle.

In cycle 1, the counter 262 adds the reference power supply voltage value V0 (0.80) to the counter value CNTv (=0.00) and holds the result as the counter value CNTv0 (=0.80). Since the counter value CNTv0 (=0.80) is smaller than the current power supply voltage value V1 (=0.85), the counter 262 sets the enable signal ENv to the low level L and sets the counter value CNTv to the counter value CNTv0. The counter value CNTv is updated in the next cycle. Since both of the enable signals ENf and ENv are at the low level L, the AND circuit 263 sets the enable signal EN to the low level L.

Next, in cycle 2, the counter 261 adds the reference frequency value F0 (1.0) to the counter value CNTf (=1.0), and holds the result as the counter value CNTf0 (=2.0). The counter value CNTf0 (=2.0) of the counter 261 is equal to or larger than the current frequency value F1 (=1.5). Therefore, the counter 261 sets the enable signal ENf to the high level H, and sets a value (=0.5) obtained by subtracting the current frequency value F1 (=1.5) from the counter value CNTf0 (=2.0) to the counter value CNTf.

In cycle 2, the counter 262 adds the reference power supply voltage value V0 (0.80) to the counter value CNTv (=0.80) and holds the result as the counter value CNTv0 (=1.60). The counter value CNTv0 (=1.60) of the counter 262 is equal to or larger than the current power supply voltage value V1 (=0.85). Therefore, the counter 262 sets the enable signal ENv to the high level H, and sets the counter value CNTv to a value (=0.75) obtained by subtracting the current power supply voltage value V1 (=0.85) from the counter value CNTv0 (=1.60). Since both of the enable signals ENf and ENv are at the high level H, the AND circuit 263 sets the enable signal EN to the high level H.

In the cycle 3 and the subsequent cycles, the counters 261 and 262 and the AND circuit 263 operate in the same manner as in the cycles 1 and 2, and set the enable signal EN to the low level L or the high level H in each cycle. For example, the issuance frequency determination unit 260 sets the enable signal EN to the high level H in 13 cycles out of 22 cycles, and the issuance rate of the floating-point arithmetic instruction is 0.59. Here, the issuance rate of the floating-point arithmetic instructions indicates a ratio of the floating-point arithmetic instructions issued to the floating-point arithmetic unit 270 to the floating-point arithmetic instructions transferred from the reservation station 230, and indicates that the higher the issuance rate is, the higher the processing efficiency is.

FIG. 8 illustrates another example of the operation of the counters 261 and 262 and the AND circuit 263 of the issuance frequency determination unit 260 in FIG. 5. Detailed description of the same operations as those in FIG. 7 will be omitted. FIG. 8 illustrates the operation when the current frequency value F1 is 1.6 GHz and the current power supply voltage value V1 is 0.95 V.

In FIG. 8, since the current frequency value F1 (=1.6 GHz) is higher than the current frequency value F1 (=1.5 GHz) in FIG. 7, the frequency of setting the enable signal ENf to the high level H is lower than that in FIG. 7. Further, since the current power supply voltage value V1 (=0.95) is higher than the current power supply voltage value V1 (=0.85) in FIG. 7, the frequency of setting the enable signal ENv to the high level H is lower than that in FIG. 7. Therefore, the frequency of setting the enable signal EN to the high level H is lower than that in FIG. 7.

For example, the issuance frequency determination unit 260 sets the enable signal EN to the high level H in six cycles out of 22 cycles, and the issuance rate of the floating-point arithmetic instruction is 0.27. That is, as one or both of the current frequency value F1 and the current power supply voltage value V1 are higher, the issuance frequency of the floating-point arithmetic instructions is lower, and the processing efficiency of the floating-point arithmetic instructions is lower.

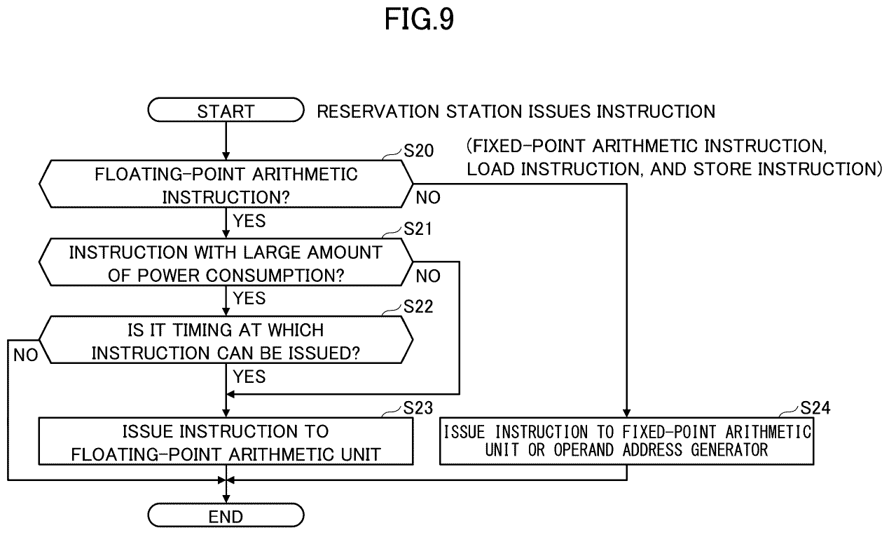

FIG. 9 illustrates an example of the operation of the instruction execution unit 220 in FIG. 3. The operation illustrated in FIG. 9 is executed every time the reservation station 230 issues an instruction. For example, FIG. 9 illustrates an operation in a case where the issuance frequency of a floating-point arithmetic instruction with large power consumption, such as an SIMD arithmetic instruction, to the floating-point arithmetic unit 270 is adjusted.

Note that the processor 100A may include respective reservation stations corresponding to the floating-point arithmetic unit 270, the fixed-point arithmetic unit 280, and an operand address generator (not illustrated in FIG. 3). In this case, the steps S20 and S24 are deleted from FIG. 9, and the operation illustrated in FIG. 9 is performed every time the reservation station 230 for floating-point arithmetic instruction use issues a floating-point arithmetic instruction.

First, in step S20, the instruction execution unit 220 determines whether the instruction received from the reservation station 230 is a floating-point arithmetic instruction. The instruction execution unit 220 executes step S21 in the case of a floating-point arithmetic instruction, and executes step S24 in the case of not a floating-point arithmetic instruction. Examples of the instruction that is not a floating-point arithmetic instruction include a fixed-point arithmetic instruction, a load instruction, and a store instruction.

In step S21, the instruction execution unit 220 determines whether the instruction is a floating-point arithmetic instruction with large power consumption. The instruction execution unit 220 executes step S22 in the case of a floating-point arithmetic instruction with large power consumption, and executes step S23 in the case of a floating-point arithmetic instruction with small power consumption. Note that, when the issuance frequency is adjusted for all of the plurality of types of floating-point arithmetic instructions with different power consumptions, step S21 is omitted.

In step S22, the instruction execution unit 220 determines whether it is a timing at which the floating-point arithmetic instruction can be issued by the issuance frequency determination unit 260 (that is, whether the enable signal EN is at a high level). The instruction execution unit 220 executes step S23 when it is the timing at which the floating-point arithmetic instruction can be issued, and ends the operation illustrated in FIG. 9 when it is not the timing at which the floating-point arithmetic instruction can be issued.

In step S23, the instruction issuance control unit 240 issues a floating-point arithmetic instruction to the floating-point arithmetic unit 270, and ends the operation illustrated in FIG. 9. The instruction issuance control unit 240 controls the issuance frequency for an instruction such as an SIMD operation instruction whose power consumption is equal to or larger than a reference value and whose power consumption reduction effect is large. On the other hand, the instruction issuance control unit 240 does not control the issuance frequency for an instruction whose power consumption is smaller than the reference value and whose power consumption reduction effect is small even if the issuance is inhibited, and immediately issues the instruction to the floating-point arithmetic unit 270.

In step S24, when the fixed-point arithmetic instruction is executable, the reservation station 230 issues the fixed-point arithmetic instruction to the fixed-point arithmetic unit 280, and ends the operation illustrated in FIG. 9. When the load instruction or the store instruction is executable, the reservation station 230 issues the load instruction or the store instruction to the operand address generator and ends the operation illustrated in FIG. 9. That is, for an instruction whose power consumption is smaller than that of the floating-point arithmetic instruction, the issuance frequency is not controlled, and the instruction is immediately issued to a corresponding arithmetic unit.

An SIMD operation instruction or the like with large power consumption has a large effect on the electric-current consumption of the processor 100A, and an instruction with small power consumption has a small effect on the electric-current consumption of the processor 100A. By controlling the issuance frequency of instructions that have a large effect on the electric-current consumption of the processor 100A, it is possible to appropriately perform control to inhibit the electric-current consumption of the processor 100A to the upper limit value or less. In contrast, when the issuance frequency of an instruction with low power consumption is also controlled, the control becomes complicated and the scale of the control circuit also increases.

As described above, the embodiment illustrated in FIGS. 3 to 9 can also provide the same effects as those of the embodiment illustrated in FIGS. 1 and 2. For example, in each core 200, the issuance frequency of floating-point arithmetic instructions is decreased even when one or both of the frequency of the clock CLK and the power supply voltage VDD are increased by the DVFS control, and the electric-current consumption of the processor 100A can be inhibited from exceeding the upper limit value.

Further, in the embodiment illustrated in FIGS. 3 to 9, the issuance frequency determination unit 260 obtains the issuance frequency of the enable signals EN from Equation (1) using the current frequency value F1, the current power supply voltage value V1, the reference frequency value F0, and the reference power supply voltage value V0. Alternatively, the issuance frequency determination unit 260 obtains the issuance frequency of the enable signals EN using a counter 261 that adds the reference frequency value F0 and subtracts the current frequency value F1, and a counter 262 that adds the reference power supply voltage value V0 and subtracts the current power supply voltage value V1. Thus, the issuance instruction selection unit 250 can adjust the issuance frequency of floating-point arithmetic instructions according to the enable signal EN from the issuance frequency determination unit 260.

When the execution of the floating-point arithmetic instruction is inhibited by a decrease in the issuance frequency of floating-point arithmetic instructions by the instruction issuance control unit 240, the floating-point arithmetic instruction is held without being deleted from the queue. This enables the reservation station 230 to re-output to the instruction issuance control unit 240 the floating-point arithmetic instruction whose execution has been inhibited in accordance with a decrease in the issue frequency. Therefore, it is possible to prevent a failure in which the inhibited floating-point arithmetic instruction is not executed, and to prevent malfunction of the processor 100A.

By controlling the issuance frequency of instructions having a large effect on the electric-current consumption of the processor 100A and not controlling the issuance frequency of instructions having a small effect on the electric-current consumption of the processor 100A, it is possible to appropriately perform control to inhibit the electric-current consumption of the processor 100A to the upper limit value or less. For example, a larger effect can be obtained by controlling the issuance frequency of SIMD operation instructions, which consume significantly larger power than SISD operation instructions.

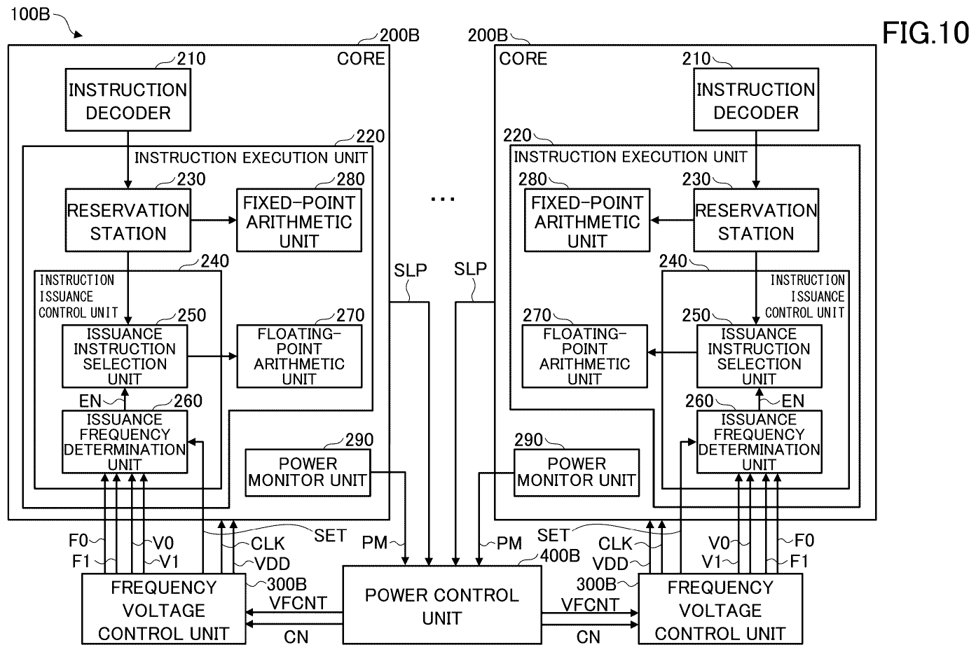

FIG. 10 illustrates an example of a processor according to another embodiment. The same reference numerals are given to the same elements as those in FIG. 3, and detailed description thereof will be omitted. The processor 100B illustrated in FIG. 10 includes a core 200B, a frequency voltage control unit 300B, and a power control unit 400B, instead of the core 200, the frequency voltage control unit 300, and the power control unit 400 illustrated in FIG. 3.

The core 200B has the same configuration and functions as the core 200 in FIG. 3 except that the core 200B outputs a sleep signal SLP to the power control unit 400B in a non-operation state where no instruction is executed. For example, the core 200B sets the sleep signal SLP to a high level in a sleep period in which the instruction is not executed and the power consumption is inhibited, and sets the sleep signal SLP to a low level in an operation period in which the instruction is executed and the power consumption increases. The sleep signal SLP is an example of state information indicating the operation state of the core 200B.

The power control unit 400B has the same functions as the power control unit 400 in FIG. 3 except that the power control unit 400B calculates the number of operating cores, which is the number of operating cores 200B, based on the sleep signal SLP and outputs a core count signal CN indicating the number of operating cores. When the number of operating cores is smaller than the total number of cores in the processor 100B, the power control unit 400B determines that the total power consumption of the processor 100B has a margin with respect to the upper limit of the power consumption of the processor 100B. The core count signal CN indicating the number of operating cores being smaller than the total number of cores is an example of margin information indicating that there is a margin in the total power consumption of the processor 100B or an example of operation count information of the core 200B.

The frequency voltage control unit 300B corresponding to the operating core 200B has a function of decreasing one or both of the current frequency value F1 and the current power supply voltage value V1 when the number of operating cores indicated by the core count signal CN is smaller than the total number of cores. The other functions of the frequency voltage control unit 300B are the same as the functions of the frequency voltage control unit 300 in FIG. 3. For example, the frequency voltage control unit 300B decreases one or both of the current frequency value F1 and the current power supply voltage value V1 as the number of operating cores indicated by the core count signal CN decreases.

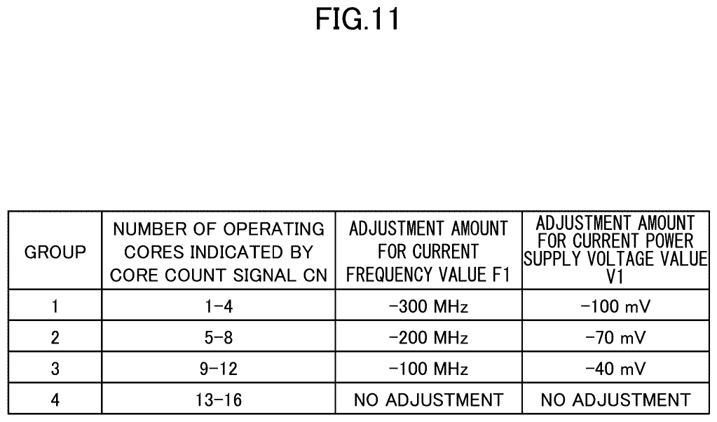

FIG. 11 illustrates an example of adjustment of the current frequency value F1 and the current power source voltage value V1 by the frequency voltage control unit 300B in FIG. 10. For example, the processor 100B has 16 cores 200B. The frequency voltage control unit 300B detects the number of operating cores 200B based on the core count signal CN from the power control unit 400B.

When the number of operating cores 200B is one to four, the frequency voltage control unit 300B sets the current frequency value F1 to be lower by 300 MHz than the actual clock CLK, and sets the current power supply voltage value V1 to be lower by 100 mV than the actual power supply voltage VDD.

When the number of operating cores 200B is 5 to 8, the frequency voltage control unit 300B sets the current frequency value F1 to be lower than the actual clock CLK by 200 MHz, and sets the current power supply voltage value V1 to be lower than the actual power supply voltage VDD by 70 mV.

When the number of operating cores 200B is 9 to 12, the frequency voltage control unit 300B sets the current frequency value F1 to be lower than the actual clock CLK by 100 MHz, and sets the current power supply voltage value V1 to be lower than the actual power supply voltage VDD by 40 mV.

When the number of operating cores 200B is 13 to 16, the frequency voltage control unit 300B sets the current frequency value F1 to the value of the actual clock CLK, and sets the current power supply voltage value V1 to the value of the actual power supply voltage VDD (no adjustment).

The frequency voltage control unit 300B outputs the adjusted current frequency value F1 and the adjusted current power supply voltage value V1 to the issuance frequency determination unit 260 together with the setting signal SET that is output when the frequency voltage control unit 300B updates the frequency of the clock CLK and the power supply voltages VDD. The issuance frequency determination unit 260 initializes the counter values CNTf and CNTv described with reference to FIG. 6 to “0” based on the setting signal SET, and replaces the current frequency value F1 and the current power supply voltage value V1 with the adjusted current frequency value F1 and current power supply voltage value V1. The operation of the issuance frequency determination unit 260 is the same as that in FIGS. 6 to 8 except that the issuance frequency of the enable signals EN is different.

By setting the current frequency value F1 and the current power supply voltage value V1 lower as the number of operating cores 200B decreases, the frequency of the enable signal EN output from the issuance frequency determination unit 260 can be increased. This makes it possible to improve the execution rate of the floating-point arithmetic instruction by the core 200B in operation.

Depending on the operation state of the processor 100B, the number of operating cores 200B may be small, and the amount of electric current may have a margin with respect to the upper limit value. In such a situation, the processing performance of the processor 100 can be improved by performing control to increase the issuance frequency of floating-point arithmetic instructions with large power consumption within a range not exceeding the upper limit of the amount of electric current. At this time, the frequency voltage control unit 300B adjusts the current frequency value F1 and the current power supply voltage value V1, thereby increasing the issuance frequency of floating-point arithmetic instructions without changing the circuit configuration of the instruction issuance control unit 240.

The number of groups for which the current frequency value F1 and the current power supply voltage value V1 are adjusted is not limited to four groups illustrated in FIG. 11. The number of cores 200B in the processor 100B is not limited to 16. The power control unit 400B may output adjustment information for adjusting current frequency value F1 and the current power supply voltage value V1 to the frequency voltage control unit 300B based on the power consumption of all the cores 200B obtained (calculated) from the power monitor information PM output from each core 200B. In this case, the power control unit 400B may not receive the sleep signal SLP.

As described above, the embodiment illustrated in FIGS. 10 and 11 can also provide the same effects as those of the embodiments illustrated in FIGS. 1 to 9. For example, in each core 200B, even when one or both of the frequency of the clock CLK and the power supply voltage VDD are increased by the DVFS control, the issuance frequency of floating-point arithmetic instructions is decreased, and thus it is possible to inhibit the electric-current consumption of the processor 100B from exceeding the upper limit value.

Further, in the embodiment illustrated in FIGS. 10 and 11, the current frequency value F1 and the current power supply voltage value V1 of each core 200B can be set to be lower as the number of operating cores 200B is smaller. Therefore, the execution rate of the floating-point arithmetic instruction by the operating core 200B can be improved, and the processing capability of the processor 100B can be improved. At this time, the frequency voltage control unit 300B adjusts the current frequency value F1 and the current power supply voltage value V1, thereby increasing the issuance frequency of floating-point arithmetic instructions without changing the circuit configuration of the instruction issuance control unit 240.

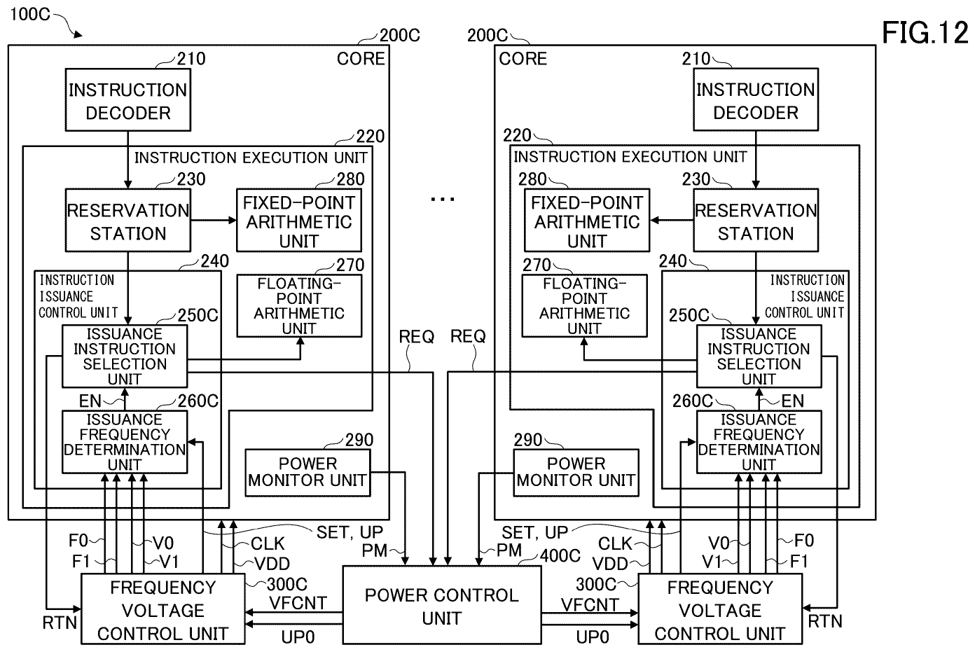

FIG. 12 illustrates an example of a processor according to another embodiment. The same reference numerals are given to the same elements as those in FIG. 3, and detailed description thereof will be omitted. The processor 100C illustrated in FIG. 12 includes a core 200C, a frequency voltage control unit 300C, and a power control unit 400C instead of the core 200, the frequency voltage control unit 300, and the power control unit 400 illustrated in FIG. 3. The instruction issuance control unit 240 includes an issuance instruction selection unit 250C and an issuance frequency determination unit 260C instead of the issuance instruction selection unit 250 and the issuance frequency determination unit 260 in FIG. 3.

Hereinafter, a state in which the frequency voltage control unit 300C outputs the current frequency value F1 indicating the actual frequency of the clock CLK and outputs the current power supply voltage value V1 indicating the actual power supply voltage VDD is referred to as a normal state. In the following, an example is described in which the issuance frequency of instructions is controlled with respect to floating-point arithmetic instructions. Note that the control of the issuance frequency of floating-point arithmetic instructions may be performed on a floating-point arithmetic instruction with large power consumption such as an SIMD arithmetic instruction as described in FIG. 9.

In the normal state, the issuance instruction selection unit 250C observes the issuance frequency of the floating-point arithmetic instructions to the floating-point arithmetic unit 270 with respect to the floating-point arithmetic instructions received from the reservation station 230 for a certain period of time. When the issuance frequency of floating-point arithmetic instructions becomes lower than a preset reference frequency, the issuance instruction selecting unit 250C detects an insufficient issuance frequency and outputs a request signal REQ for requesting an improvement in the issuance frequency to the power control unit 400C.

The issuance instruction selecting unit 250C has the same functions as the issuance instruction selecting unit 250 in FIG. 3 except that the issuance instruction selecting unit 250C outputs the request signal REQ. The request signal REQ is an example of insufficient frequency information indicating an insufficient issuance frequency of the floating-point arithmetic instructions. The request signal REQ may be output to the power control unit 400C via the frequency voltage control unit 300C.

When the power control unit 400C receives the request signal REQ at the time at which the total power consumption of the processor 100C has a margin, the power control unit 400C outputs a frequency-increase signal UP0 indicating an increase in the issuance frequency to the frequency voltage control unit 300C connected to the core 200C that has output the request signal REQ. Here, when the total power consumption of the processor 100C is smaller than the upper limit of the power consumption of the processor 100C, the power control unit 400C determines that there is a margin in the total power consumption and outputs the frequency-increase signal UP0 according to the margin of the total power consumption. For example, the value of the frequency-increase signal UP0 indicated by a plurality of bits is larger as the margin of the total power consumption is larger. The value of the frequency-increase signal UP0 is an example of frequency-increase information.

The frequency voltage control unit 300C that has received the frequency-increase signal UP0 decreases one or both of the current frequency value F1 and the current power supply voltage value V1 as the margin indicated by the frequency-increase signal UP0 increases. Then, the frequency voltage control unit 300C outputs the current frequency value F1 and the current power supply voltage value V1, one or both of which have been changed, and an increased-state signal UP indicating an increased state of the issuance frequency to the issuance frequency determination unit 260C together with the setting signal SET.

When the issuance frequency determination unit 260C receives the increased-state signal UP, the issuance instruction selection unit 250C holds the issuance frequency of floating-point arithmetic instructions received from the reservation station 230. The issuance frequency determination unit 260C initializes the counters 261 and 262 in FIG. 5, and then generates the enable signal EN by using the changed current frequency value F1 and the changed current power supply voltage value V1 received from the frequency voltage control unit 300C.

When the insufficient issuance frequency is detected, the output frequency of high-level enable signals EN output by the issuance frequency determination unit 260C can be increased by decreasing one or both of the current frequency value F1 and the current power supply voltage value V1. Thus, the issuance frequency of floating-point arithmetic instructions can be increased. That is, in the core 200C that has requested an improvement in the issuance frequency, the issuance frequency of floating-point arithmetic instructions to the floating-point arithmetic unit 270 can be improved.

After the issuance frequency determination unit 260C receives the increased-state signal UP, the issuance instruction selection unit 250C observes the issuance frequency of floating-point arithmetic instructions received from the reservation station 230 for a certain period of time. When the issuance frequency by the reservation station 230 becomes lower than the issuance frequency held when the increased-state signal UP is received, the issuance instruction selection unit 250C determines that the issuance frequency of floating-point arithmetic instructions to the floating-point arithmetic unit 270 does not have to be improved.

Since the insufficient issuance frequency of the floating-point arithmetic instructions is restored, the issuance instruction selection unit 250C outputs a return signal RTN for returning the current frequency value F1 and the current power supply voltage value V1 to the normal state to the frequency voltage control unit 300C. The return signal RTN is an example of a restoration signal indicating that the insufficient issuance frequency of floating-point arithmetic instructions has been restored.

The frequency voltage control unit 300C that has received the return signal RTN returns the current frequency value F1 and the current power supply voltage value V1 to be output to the issuance frequency determination unit 260C to the normal state. That is, the current frequency value F1 is set to a value indicating the actual clock CLK frequency, and the current power supply voltage value V1 is set to a value indicating the actual power supply voltage VDD.

When the frequency voltage control unit 300C returns the current frequency value F1 and the current power supply voltage value V1 to be output to the issuance frequency determination unit 260C to the normal state, the frequency voltage control unit 300C outputs the setting signal SET and stops outputting the increased-state signal UP. As a result, the issuance frequency determination unit 260C initializes the counter values CNTf and CNTv to “0”, and outputs the enable signal EN at a predetermined frequency by using the current frequency value F1 and the current power supply voltage value V1 in the normal state, as illustrated in FIGS. 6 to 8.

Thus, the issuance frequency determination unit 260C can generate the enable signal EN at the frequency in the normal state by using the original current frequency value F1 and the original current power supply voltage value V1 before receiving the increased-state signal UP.

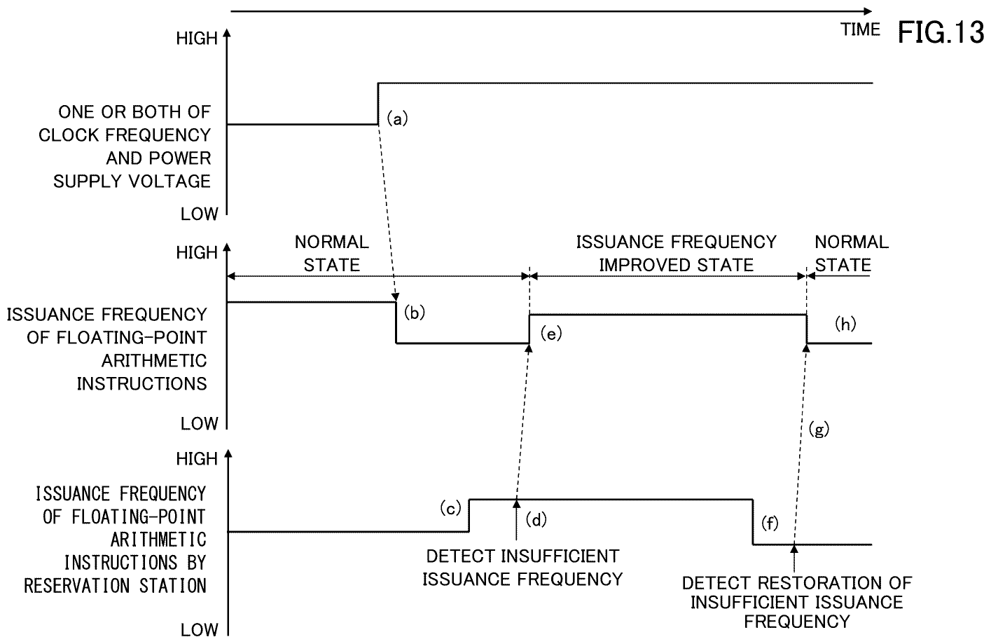

FIG. 13 illustrates an example of the operation when the issuance frequency of floating-point arithmetic instructions is insufficient in each core 200C of the processor 100C in FIG. 12. Detailed description of the same operations as those in FIG. 2 will be omitted. FIG. 13 illustrates an example of the operation of the core 200C that has output the request signal REQ. The operation of lowering the issuance frequency of floating-point arithmetic instructions based on the increase in one or both of the frequency of the clock CLK and the power supply voltage VDD is the same as that in FIG. 2 (FIGS. 13 (a) and (b)).

In FIG. 13, first, the issuance frequency of the floating-point arithmetic instructions are controlled by using the current frequency value F1 and the current power supply voltage value V1 in the normal state corresponding to the actual frequencies of the clocks CLK and the actual power supply voltage VDD. After the issuance frequency of the floating-point arithmetic instructions is decreased, the issuance frequency of the floating-point arithmetic instructions from the reservation station 230 is increased due to, for example, a change in the program executed by the core 200C (FIG. 13 (c)).

Thereafter, in the normal state, the issuance instruction selection unit 250C observes the issuance frequency of the floating-point arithmetic instructions. Then, the issuance instruction selection unit 250C detects that the issuance frequency of floating-point arithmetic instructions issued to the floating-point arithmetic unit 270 is lower than the issuance frequency of floating-point arithmetic instructions from the reservation station 230. That is, the issuance instruction selection unit 250 detects the insufficient issuance frequency (FIG. 13 (d)).

As described with reference to FIG. 12, the issuance instruction selection unit 250 outputs the request signal REQ to the power control unit 400C, and the power control unit 400C outputs the frequency-increase signal UP0 to the frequency voltage control unit 300C. As a result, the current frequency value F1 and the current power supply voltage value V1 are set to be lower than those in the normal state, and the core 200C that has output the request signal REQ enters the issuance frequency improved state in which the issuance frequency of floating-point arithmetic instructions to the floating-point arithmetic unit 270 is increased (FIG. 13 (e)).

Thereafter, for example, the issuance frequency of floating-point arithmetic instructions from the reservation station 230 is reduced due to a change in the program executed by the core 200C or the like (FIG. 13 (f)). In the issuance frequency improved state, the issuance instruction selection unit 250C observes the issuance frequency of the floating-point arithmetic instructions. When the issuance frequency of floating-point arithmetic instructions becomes equal to or lower than the issuance frequency in the normal state before receiving the increased-state signal UP, the issuance instruction selecting unit 250C detects the restoration of the insufficient issuance frequency (FIG. 13 (g)).

Based on the detection of the restoration of the insufficient issuance frequency by the issuance instruction selection unit 250C, the frequency voltage control unit 300C returns the current frequency value F1 and the current power supply voltage value V1 to be output to the issuance frequency determination unit 260C to the normal state. As a result, the issuance frequency of floating-point arithmetic instructions is returned to the original state before receiving the increased-state signal UP (FIG. 13 (h)).

By performing the control illustrated in FIG. 13, when the program to be executed is switched and the issuance frequency of floating-point arithmetic instructions with large power consumption is insufficient, the issuance frequency can be increased for each core 200C in which the issuance frequency is insufficient.

Depending on the program executed by the processor 100C, the issuance frequency of floating-point arithmetic instructions with large power consumption may be insufficient. For example, highly parallel programs used in the High Performance Computing (HPC) area may use floating-point arithmetic instructions more frequently.

At this time, depending on operation states of the frequency and voltage, the issuance frequency of floating-point arithmetic instructions to the floating-point arithmetic unit 270 may be insufficient, and the expected performance may not be obtained. In such a situation, when the power consumption of the processor 100C has a margin, the processing capability can be improved by performing control to increase the issuance frequency of floating-point arithmetic instructions to the core 200C that has an insufficient issuance frequency of floating-point arithmetic instructions.

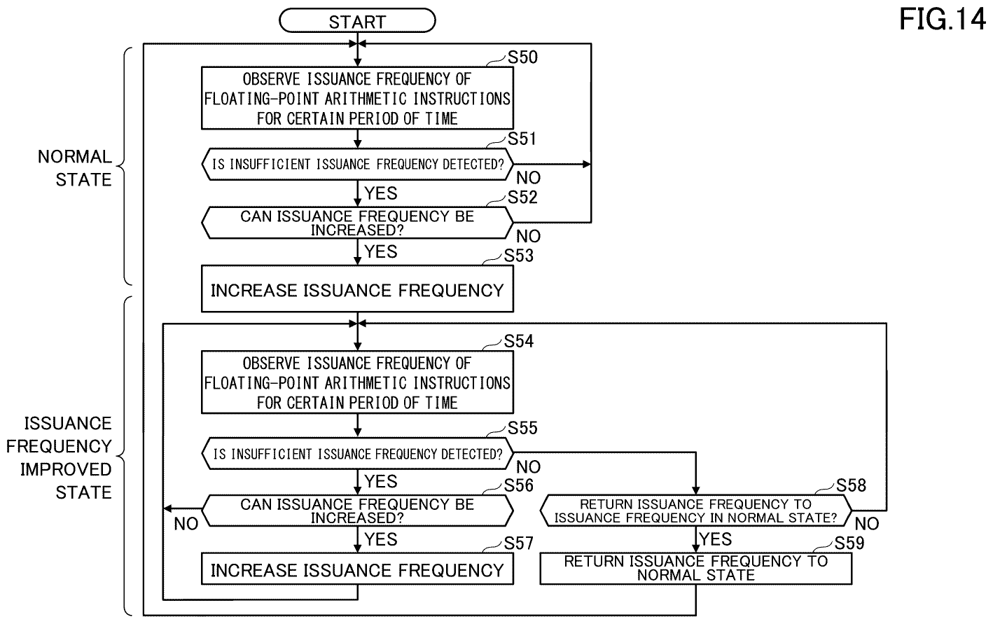

FIG. 14 illustrates an example of the operation of each core 200C of the processor 100C in FIG. 12. For example, the operation illustrated in FIG. 14 is started in the normal state when the processor 100C is activated.

First, in step S50, the issuance instruction selection unit 250C observes the issuance frequency of floating-point arithmetic instructions for a certain period of time. Next, in step S51, the issuance instruction selection unit 250C detects whether the issuance frequency of the floating-point arithmetic instructions is insufficient based on the observation result. When the issuance frequency is insufficient, the operation of step S52 is performed, and when the issuance frequency is not insufficient, the operation returns to step S50.

In step S52, the power control unit 400C determines whether the issuance frequency of floating-point arithmetic instructions can be increased based on the margin of the entire power consumption of the processor 100C. When the issuance frequency can be increased, the operation of step S53 is performed, and when the issuance frequency is unable to be increased, the operation returns to step S50.

In step S53, the power control unit 400C outputs the frequency-increase signal UP0 to the frequency voltage control unit 300C, and causes the frequency voltage control unit 300C to perform control to increase the issuance frequency of floating-point arithmetic instructions. The core 200C is shifted from the normal state to the issuance frequency improved state, and increases the issuance frequency of the floating-point arithmetic instructions.

After the state is shifted to the issuance frequency improved state, in step S54, the issuance instruction selecting unit 250C observes the issuance frequency of floating-point arithmetic instructions for a certain period of time. Next, in step S55, the issuance instruction selection unit 250C detects whether the issuance frequency of the floating-point arithmetic instructions is insufficient based on the observation result. When the issuance frequency is insufficient, the operation of step S56 is performed, and when the issuance frequency is not insufficient, the operation of step S58 is performed.

In step S56, the power control unit 400C determines whether the issuance frequency of floating-point arithmetic instructions can be increased based on the margin of the entire power consumption of the processor 100C. When the issuance frequency can be increased, the operation of step S57 is performed, and if the issuance frequency is unable to be increased, the operation returns to step S54.

In step S57, the power control unit 400C outputs the frequency-increase signal UP0 to the frequency voltage control unit 300C, and causes the frequency voltage control unit 300C to perform control to increase the issuance frequency of floating-point arithmetic instructions. That is, when there is a margin in the total power consumption of the processor 100C in the issuance frequency improved state, the core 200C can further increase the issuance frequency of the floating-point arithmetic instructions. After step S57, the operation returns to step S54.

When the insufficient issuance frequency of floating-point arithmetic instructions is restored, the issuance instruction selection unit 250C determines whether to return the issuance frequency to the issuance frequency in the normal state in step S58. When the issuance frequency is returned to the issuance frequency in the normal state, the issuance instruction selection unit 250C outputs the return signal RTN to the frequency voltage control unit 300C, and in step S59, the frequency voltage control unit 300C performs control to return the issuance frequency to the normal state. When the issuance frequency improved state is maintained, the operation returns to step S54.

As described above, the embodiment illustrated in FIGS. 12 to 14 can also obtain the same effect as the embodiments illustrated in FIGS. 1 to 9. For example, in each core 200C, even when one or both of the frequency of the clock CLK and the power supply voltage VDD are increased by the DVFS control, the issuance frequency of floating-point arithmetic instructions is decreased, and thus it is possible to inhibit the electric-current consumption of the processor 100C from exceeding the upper limit value.

Further, in the embodiment illustrated in FIGS. 12 to 14, one or both of the current frequency value F1 and the current power supply voltage value V1 output to the core 200C in which the insufficient issuance frequency of floating-point arithmetic instructions is detected are decreased. This makes it possible to increase the issuance frequency of floating-point arithmetic instructions for each core 200C in which the insufficient issuance frequency is detected. When the power consumption of the processor 100C has a margin, the processing capability can be improved by performing control to increase the issuance frequency of floating-point arithmetic instructions to the core 200C in which the insufficient issuance frequency of floating-point arithmetic instructions is detected.

When the insufficient issuance frequency of floating-point arithmetic instructions is restored during the issuance frequency improved state, one or both of the current frequency value F1 and the current supply voltage value V1 can be returned to the normal state to generate the enable signal EN at the frequency before receiving the increased-state signal UP.

The functions of FIGS. 10 and 11 may be provided to the embodiment illustrated in FIGS. 12 to 14. That is, the sleep signal SLP may be output from each core 200C to the power control unit 400C, and the current frequency value F1 and the current power supply voltage value V1 of each core 200C may be set to be lower as the number of operating cores 200C is smaller.

The features and advantages of the embodiments will be apparent from the detailed description given above. This is intended to cover the features and advantages of the embodiments described above within the scope of the claims without departing from the spirit and scope of the claims. In addition, those skilled in the art will readily conceive of various modifications and changes. Therefore, the scope of the embodiments having the invention is not intended to be limited to the above-described embodiments, and appropriate improvements and equivalents included in the scope disclosed in the embodiments can be made.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A processor comprising:
a plurality of cores each including a floating-point arithmetic unit;
a frequency voltage control unit provided corresponding to each of the plurality of cores, the frequency voltage control unit being configured to supply a clock having a variable frequency and a power supply voltage having a variable voltage to the corresponding core; and
an instruction issuance control unit provided in each of the plurality of cores, the instruction issuance control unit being configured to control issuance of a floating-point arithmetic instruction to the floating-point arithmetic unit and lower an issuance frequency of floating-point arithmetic instructions to the floating-point arithmetic unit as a current frequency value of the clock is larger than a reference frequency value, or as a current power supply voltage value is larger than a reference power supply voltage value.

2. The processor as claimed in claim 1,
wherein the instruction issuance control unit issues the floating-point arithmetic instruction to the floating-point arithmetic unit at an issuance frequency (equal to or smaller than “1”) obtained by a product of a ratio F0/F1 of the reference frequency value F0 to the current frequency value F1 and a ratio V0/V1 of the reference power supply voltage value V0 to the current power supply voltage value V1.

3. The processor as claimed in claim 1,
wherein the frequency voltage control unit outputs the reference frequency value, the current frequency value, the reference power supply voltage value, and the current power supply voltage value to the instruction issuance control unit, and
wherein the instruction issuance control unit includes
a first counter configured to operate in a cycle in which a floating-point arithmetic instruction is issued to the floating-point arithmetic unit and to which the reference frequency value is sequentially added, and
a second counter configured to operate in a cycle in which a floating-point arithmetic instruction is issued to the floating-point arithmetic unit and to which the reference power supply voltage value is sequentially added,
wherein the instruction issuance control unit
repeats an operation of subtracting the current frequency value from a first counter value when the first counter value of the first counter becomes equal to or larger than the current frequency value, and subtracting the current power supply voltage value from a second counter value when the second counter value of the second counter becomes equal to or larger than the current power supply voltage value,
issues a floating-point arithmetic instruction to the floating-point arithmetic unit in the cycle in which the first counter value is equal to or larger than the current frequency value and the second counter value is equal to or larger than the current power supply voltage value, and
inhibits issuing of the floating-point arithmetic instruction to the floating-point arithmetic unit in the cycle in which the first counter value is smaller than the current frequency value or in the cycle in which the second counter value is smaller than the current power supply voltage value.

4. The processor as claimed in claim 1,
wherein each of the plurality of cores includes:
an instruction decoder configured to decode a floating-point arithmetic instruction; and
a scheduler including a queue for holding floating-point arithmetic instructions decoded by the instruction decoder, the scheduler being configured to output the floating-point arithmetic instructions held in the queue to the instruction issuance control unit in an executable order, and inhibit deletion of a floating-point arithmetic instruction from the queue, the floating-point arithmetic instruction being inhibited from being issued from the instruction issuance control unit to the floating-point arithmetic unit in accordance with a decrease in the issuance frequency of floating-point arithmetic instructions.

5. The processor as claimed in claim 4,
wherein the floating-point arithmetic instruction includes a plurality of types of floating-point arithmetic instructions with different power consumptions during execution by the floating-point arithmetic unit,
wherein, when the instruction decoder decodes a floating-point arithmetic instruction whose power consumption during execution by the floating-point arithmetic unit is equal to or larger than a reference value, the instruction decoder adds a high-frequency flag to the decoded floating-point arithmetic instruction and stores the decoded floating-point arithmetic instruction to which the high-frequency flag is added in the scheduler, and
wherein the instruction issuance control unit controls the issuance frequency of floating-point arithmetic instructions to which the high-frequency flag is added, and issues a floating-point arithmetic instruction to which the high-frequency flag is not added to the floating-point arithmetic unit without controlling the issuance frequency of floating-point arithmetic instructions.

6. The processor as claimed in claim 5,
wherein the floating-point arithmetic instruction whose power consumption is equal to or larger than the reference value is a single instruction multiple data (SIMD) arithmetic instruction.

7. The processor as claimed in claim 4,
wherein each of the plurality of cores includes a fixed-point arithmetic unit,
wherein the instruction decoder decodes a floating-point arithmetic instruction and a fixed-point arithmetic instruction, and
wherein the scheduler holds the floating-point arithmetic instruction and the fixed-point arithmetic instruction decoded by the instruction decoder in the queue, and outputs the fixed-point arithmetic instruction held in the queue to the fixed-point arithmetic unit without passing through the instruction issuance control unit.

8. The processor as claimed in claim 1, further comprising:
a power control unit configured to obtain a total power consumption of the plurality of cores from power information indicating power consumption received from each of the plurality of cores, and output change information for changing the frequency of the clock and the power supply voltage to the frequency voltage control unit corresponding to a corresponding core of the plurality of cores based on the obtained total power consumption,
wherein the frequency voltage control unit changes the frequency of the clock and the power supply voltage supplied to the corresponding core based on the change information, and outputs the current frequency value indicating the changed frequency of the clock and the current power supply voltage value indicating the changed power supply voltage to the instruction issuance control unit of the corresponding core of the plurality of cores.

9. The processor as claimed in claim 8,
wherein the power control unit outputs margin information indicating that there is a margin in the total power consumption to the frequency voltage control unit when the total power consumption is smaller than an upper limit of the power consumption of the processor, and
wherein the frequency voltage control unit reduces one or both of the current frequency value and the current power supply voltage value output to the instruction issuance control unit of the corresponding core when the margin information is received.

10. The processor as claimed in claim 8,
wherein the power control unit obtains a number of operating cores from state information indicating an operation state of a core received from each of the plurality of cores, and outputs operation count information indicating the obtained number of operating cores to the frequency voltage control unit, and
wherein the frequency voltage control unit corresponding to the operating core reduces one or both of the current frequency value and the current power supply voltage value to be output to the instruction issuance control unit of the operating core as the number of operating cores is smaller than the total number of cores.

11. The processor as claimed in claim 8,
wherein each of the plurality of cores outputs insufficient frequency information to the power control unit when detecting an insufficient issuance frequency of floating-point arithmetic instructions,
wherein, when the total power consumption is smaller than an upper limit of power consumption of the processor, the power control unit outputs frequency-increase information corresponding to a margin of the total power consumption to the frequency voltage control unit corresponding to a corresponding core of the plurality of cores that has output the insufficient frequency information, and
wherein the frequency voltage control unit that has received the frequency-increase information reduces one or both of the current frequency value and the current power supply voltage value to be output to the corresponding core, according to the frequency-increase information.

12. The processor as claimed in claim 11,
wherein each of the plurality of cores outputs a restoration signal to the frequency voltage control unit when the insufficient issuance frequency of floating-point arithmetic instructions is restored, and
wherein the frequency voltage control unit that has received the restoration signal outputs, to a corresponding core of the plurality of cores, an original current frequency value and an original current power supply voltage value before receiving the frequency-increase information from the power control unit.

13. A method for controlling operation of a processor, the processor including a plurality of cores, the plurality of cores each including a floating-point arithmetic unit, a frequency voltage control unit provided corresponding to each of the plurality of cores and configured to supply a clock having a variable frequency and a power supply voltage having a variable voltage to the corresponding core, and an instruction issuance control unit provided in the each of the plurality of cores, the method comprising:
causing the instruction issuance control unit to:
control issuance of a floating-point arithmetic instruction to the floating-point arithmetic unit; and
lower an issuance frequency of floating-point arithmetic instructions to the floating-point arithmetic unit as a current frequency value of the clock is larger than a reference frequency value, or as a current power supply voltage value is larger than a reference power supply voltage value.
